(19) United States
(12) Patent Application Publication
(10) Pub. No.: US 2025/0222530 A1
(43) Pub. Date: Jul. 10, 2025

(54) PANEL SAW

(71) Applicant: Milwaukee Electric Tool Corporation, Brookfield, WI (US)

(72) Inventors: Michael Rohrer, Brookfield, WI (US); Terry Timmons, Brookfield, WI (US); Kresten Atkins, Brookfield, WI (US)

(21) Appl. No.: 19/009,587

(22) Filed: Jan. 3, 2025

Related U.S. Application Data
(60) Provisional application No. 63/619,624, filed on Jan. 10, 2024.

(51) Int. Cl. B23D 61/12; B23D 55/08

(52) U.S. Cl. CPC B23D 61/12; B23D 55/082

(57) ABSTRACT

A panel saw including: a housing supporting a motor-driven spindle that moves in reciprocation; a blade coupled to the spindle; a stabilizer extending away from the housing and spaced apart from the blade; a terminal guide structure coupled to a distal end the stabilizer, wherein the terminal guide structure comprises: one or more lateral guide surfaces configured to support the blade in a desired cutting plane; a rear support configured to support a rear edge of the blade; or a combination thereof.

### CROSS-REFERENCE TO RELATED APPLICATIONS

The present application claims priority to U.S. Provisional Application Ser. No. 63/619,624 filed on Jan. 10, 2024, the disclosure of which is incorporated by reference herein in its entirety.

### FIELD

The present disclosure relates generally to cutting implements, and more particularly to panel saws and supporting structures for facilitating use of panel saws when cutting large objects, such as insulated panels.

### BACKGROUND

Traditionally, cutting into thick objects like insulated panel was performed using hand powered saws with sharp teeth. When pushed and/or pulled through the object, the sharp teeth scrape material from the object, resulting in the formation of a kerf, or slit, in the material. Over time, hand saws were replaced by powered saws. Powered saws utilize a blade that is pushed and/or pulled (or even rotated) to form the kerf.

Insulated panels are relatively thick and include a multi-layer construction with a metal or composite structural skin layer. Traditional cutting implements are not designed to cut through thick materials, particularly when a relatively strong (e.g., metal or composite) structural skin layer is present. Therefore, improved panel saws are desired in the art.

### BRIEF DESCRIPTION

Aspects and advantages of the invention in accordance with the present disclosure will be set forth in part in the following description, or may be obvious from the description, or may be learned through practice of the technology.

In accordance with one embodiment, a panel saw is provided. The panel saw includes a housing supporting a motor-driven spindle that moves in reciprocation; a blade coupled to the spindle; a stabilizer extending away from the housing and spaced apart from the blade; a terminal guide structure coupled to a distal end the stabilizer, wherein the terminal guide structure comprises: one or more lateral guide surfaces configured to support the blade in a desired cutting plane; a rear support configured to support a rear edge of the blade; or a combination thereof.

In accordance with another embodiment, an attachment for a panel saw is provided. The attachment for a panel saw includes a stabilizer defining a proximal end and a distal end, the stabilizer comprising a proximal attachment protocol disposed at the proximal end and a distal attachment protocol disposed at the distal end, wherein the proximal attachment protocol is configured to attach the stabilizer to a housing of the panel saw, the housing containing a motor configured to drive a spindle to reciprocate a blade; a terminal guide structure coupled to the stabilizer at the distal attachment protocol, wherein the terminal guide structure comprises: a lateral guide surface configured to support a lateral aspect of the blade of the panel saw in a desired cutting plane; a rear support configured to support a rear edge of the blade; or a combination thereof.

In accordance with another embodiment, a method of using a panel saw is provided. The method includes positioning a blade of the panel saw at a cut location of an object; moving the panel saw across the object such that the blade moves within the object to form a kerf; causing a stabilizer disposed behind the blade to enter the kerf, wherein the stabilizer extends fully through the object such that a distal end of the stabilizer is exposed from the object; and supporting the blade using a terminal guide structure coupled to the distal end of the stabilizer.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a perspective view of a panel saw cutting into an object in accordance with embodiments of the present disclosure;

FIG. 2 is a side view of a housing and internal components of the panel saw as seen with a portion of the housing removed in accordance with embodiments of the present disclosure;

FIG. 3 is a side view of a blade and a stabilizer in operational alignment as seen with the panel saw removed in accordance with embodiments of the present disclosure;

FIG. 4 is a top view of the blade and stabilizer in operational alignment as seen with the panel saw removed in accordance with embodiments of the present disclosure;

FIG. 5 is an exploded perspective view of a terminal guide structure for use on the stabilizer in accordance with embodiments of the present disclosure;

FIG. 6 is a flow chart of a method of using a panel saw in accordance with embodiments of the present disclosure; and

FIG. 7 is a perspective view of a panel saw in accordance with another embodiment of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Embodiments described herein are directed to panel saws, and more particularly to handheld panel saws. In particular, the embodiments described herein provide high accuracy cutting of relatively thick materials, such as insulated panels.

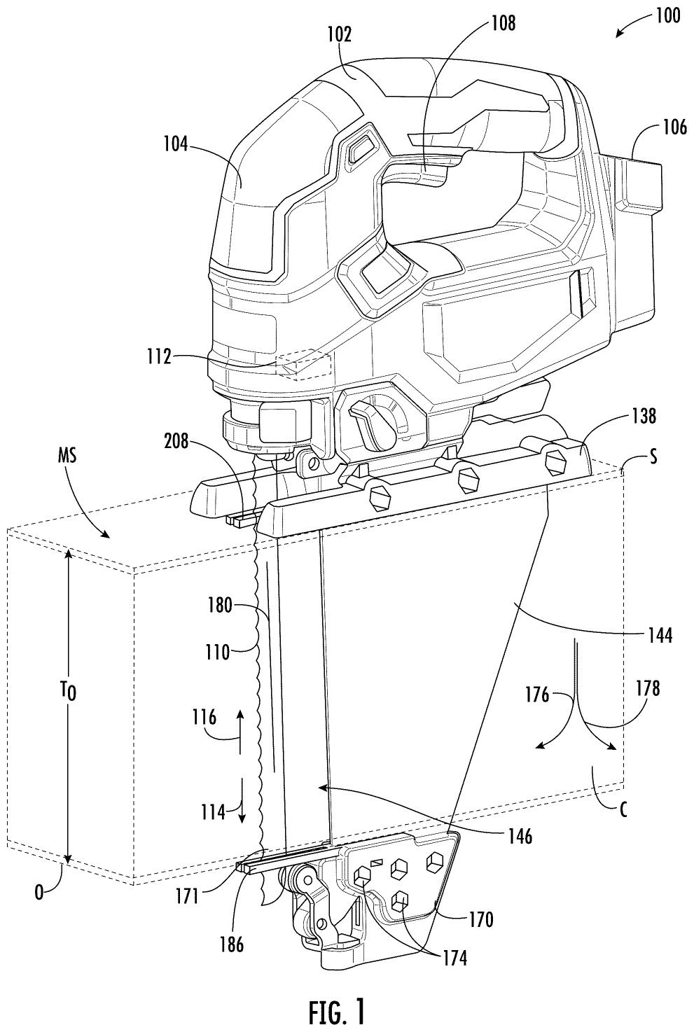

Insulated panels, sometimes referred to as sandwich panels, include a core C and a skin S (see FIG. 1) that structurally reinforces the core and mitigates environmental contamination thereof. The skin further provides mounting locations for fasteners (e.g., threaded fasteners) used to attach the insulated panel to an underlying or neighboring structure. Insulated panels provide thermal and acoustic insulation properties. The thicker the core, i.e., as measured between opposite major surfaces thereof, the greater the insulating properties. It is common for core thickness to be three (3) inches, four (4) inches, five (5) inches, six (6) inches, or even more. In some implementations, the core may be structurally reinforced by a skin disposed on only one side of the core. In other implementations, the core may be structurally reinforced by skins disposed on opposite major surfaces. Some insulated panels have planar major surfaces, resulting in constant thickness of the panel. Other insulated panels include corrugations or ridges that effectively increase the overall thickness of the panel, i.e., as measured from a peak on a first side to a peak on a second side.

Insulated panel cores come in many forms. For example, the core may consist of a foam, a honeycomb lattice, or a corrugated material. Example foam cores include polyurethane (PUR) cores, polyisocyanurate (PIR) cores, phenolic foam (PF) cores, polystyrene core (including extruded polystyrene or expanded polystyrene), mineral wool, and the like. Honeycomb lattices are often formed from rigid materials.

The skin also comes in many forms. For example, the skin can include a metal (such as steel or aluminum), organic fibers (like wood), fiberglass, strong polymers, and other composite or alloy materials.

Typically, the core is interposed between two skin members. The two skin members and the core are often laminated together. In some implementations, the two skin members can be relatively the same as one another. For example, the two skin members can each be formed from a metal. In another implementation, the two skin members can be different from one another. For example, one skin member can be formed from a metal or other environmentally resistant material and the second skin member can be formed from a finished material. These non-symmetrical arrangements (i.e., where the two skin members are different from one another) may be particularly suitable in applications where the insulated panel is used as an exposed element where aesthetic appearance matters, such as for example, an interior wall of a building or vehicle. The interior skin member can be aesthetically pleasing while the exterior skin member has a higher concern for strength.

Insulated panels may be formed using a variety of processes. By way of example, one method of forming an insulated panel is to extrude the core material between two skin members and weld each of the layers in a molten state using fusion heat. Another method of forming insulated panels is an injection process in which the core is injected between two skin members. Typically, the injected molded core is pressed into an inner sealed mold between two skin members.

Insulated panels are frequently used for walls, roofs, body panels of vehicles, and the like. As such, insulated panels are frequently exposed to environmental contact. It is thus necessary for insulated panels to have relatively strong composition. For instance, the insulated panels must be able to withstand high winds, hail, physical impact, and the like. To ensure longevity in such environments, the core is usually formed from a rigid resin with a high Young's modulus. Moreover, the skin member(s) are often formed from relatively low-gauge material, such as 22 gauge (0.759 mm thick), 24 gauge (0.607 mm thick), or 26 gauge (0.454 mm thick).

As such, cutting into insulated panels has long posed a problem for builders as insulated panels are typically shipped in standard sizes and cut to size in the field, e.g., at a house, warehouse, storage facility, manufacturer facility, or the like. In all of these environments, large industrial tools are often not available, forcing the cut to be made by one or more smaller cutting implements. Many cutting implements lack the ability to plunge a sufficient depth into the insulated panel to make a clean cut through the insulated panel. For example, circular saws generally lack the ability to penetrate six (6) or more inches to cut into insulated panels. Cutting implements that are able to penetrate fully through the insulated panel often include unsupported cutting members which results in the cutting member bending under the load of the cut. For example, jigsaws include elongated blades that are reciprocated at high speeds. For more rigid materials, the jigsaw blade has a tendency to bend or walk along the surface of the material. For honeycomb lattices and other core designs with gaps, the jigsaw blade similarly has a tendency to bend or walk. As a result, the cut edge of the insulated panel is not square and thus unable to easily fit in a desired location. Most builders that rely on insulated panels thus rely on hand saws or cut only partially into the insulated panel from both sides. However, neither of these approaches is time efficient and may still result in unsquared cut edges.

Embodiments described herein are particularly suitable for cutting into thick workpieces, such as insulated panel, while preserving edge integrity for proper alignment and panel installation.

In an embodiment, a work tool described herein is suitable for cutting into thick panels. The work tool is a handheld power tool, easily maneuverable between jobsites. The work tool is lightweight (e.g., weighing less than ten (10) pounds). The work tool includes an electric motor that operates using electrical charge received, for example, from a removable, rechargeable battery or from a wall outlet or other electrical power source. The work tool includes an adjustable throttle to control blade speed based on user preference and an object being cut. The work tool defines a stabilizer that extends through a kerf created by the blade. The stabilizer supports the blade at an opposite side of the object. The stabilizer prevents the blade from bending and/or twisting. As a result, the work tool creates a perpendicular cut that is easily aligned with neighboring surfaces and edges during installation of the object.

In an embodiment, the work tool is a panel saw. The panel saw includes a housing that defines an interior in which a motor is at least partially arranged. The motor drives a spindle to reciprocate a blade. The blade includes sharpened teeth that reciprocate within the object to form the kerf.

The panel saw further comprises a terminal guide structure that supports the blade during reciprocation. The terminal guide structure is disposed on a stabilizer. The stabilizer is disposed in series with the blade, e.g., behind the blade, and passes through the kerf. The terminal guide structure is disposed at or near a distal end of the stabilizer. The stabilizer can be fixed to the panel saw housing such that terminal guide structure is static relative to the housing of the panel saw. In this regard, reciprocation of the blade does not impact the stabilizer or terminal guide structure, allowing the terminal guide structure to guide the blade during reciprocation.

The terminal guide structure can include one or more structures that interact with and support the blade. For example, the terminal guide structure can include guide surfaces that laterally support the blade and prevent bending and twisting of the blade during movement through the object. In some implementations, the guide surfaces support the blade through physical contact. For example, the blade can rub against the guide surfaces after nominal deflection and/or twisting. In other implementations, the guide surfaces support the blade through contactless interfacing. For instance, the guide surfaces can include magnet(s) which repel the blade to a central position relative to the terminal guide structure. By way of another example, the terminal guide structure can include a rear support that contacts a rear edge of the blade. The rear support can include, for example, a wheel defining a track in which the blade moves. The wheel can press into the rear edge of the blade, particularly under heavy rearward loading when cutting through thick and/or hard panels, to prevent torque on the spindle which might otherwise damage the motor or other structure of the panel saw. The wheel can be manipulated to adjust blade pressure. These and other features of the panel saw will be described in greater detail with reference to the figures.

FIG. 1 illustrates a panel saw 100 in accordance with an example embodiment. The panel saw 100 is a handheld power tool that is grasped at a handle 102 by an operator. In an embodiment, the handle 102 extends in a direction parallel, or generally parallel, with a major surface MS of an object O being cut. The panel saw 100 further includes a housing 104, a power implement 106, and a throttle 108. In an embodiment, the power implement 106 includes a battery receiving port that releasably engages with a rechargeable battery. In another embodiment, the power implement 106 includes a power cord that extends to and is interposable with a wall outlet to receive alternating current therefrom. In yet other embodiments, the power implement 106 can include a non-removable battery, a gas-powered engine, or the like. The throttle 108 is movable between a rest position, whereby the panel saw 100 is not active, and an activated position, whereby the panel saw 100 is activated to drive a blade 110. The blade 110 is attached to a drive element 112 that reciprocates the blade 110 into 114 and out of 116 the object O.

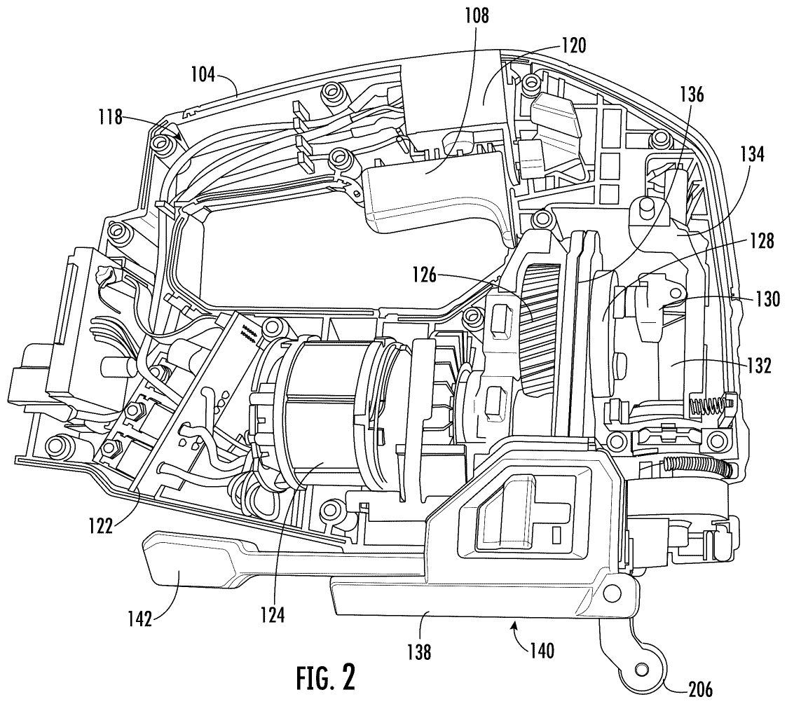

FIG. 2 illustrates the panel saw 100 with half of the housing 104 removed to show components disposed in an interior 118 of the housing 104. As depicted, the throttle 108 is in communication with a switch 120 that detects when the throttle 108 is depressed. The switch 120 can be a variable speed switch that detects a relative position of the throttle 108 and generates an output signal indicative of the relative displacement of the throttle 108. A control module 122 receives signals from the switch 120 and controls a motor 124 in response to the signal using power provided at the power implement 106. The control module 122 can include, for example, one or more processors operably coupled to memory that store instructions that when executed by the processor affect operation of the panel saw 100. The motor drives the drive element 112, e.g., through a gearbox 126, to reciprocate the blade 110 (FIG. 1). The drive element 112 can include, for example, an off-center rotary component 128 having a finger 130 that drives a spindle 132 coupled to the blade 110. The spindle 132 is guided to reciprocate by a guide member 134. A counterweight 136 is often driven in reverse to counteract the force imparted on the panel saw 100 by the blade 110.

The panel saw 100 further includes a shoe 138 having a support surface 140 which rests on the object O (FIG. 1) when cutting the object O. The shoe 138 may be removable from the housing 104 using a shoe lever 142 or other releasing mechanism.

Referring again to FIG. 1, the panel saw 100 further includes a stabilizer 144 that extends away from the housing 104 in a same, or substantially similar, direction as the blade 110. The stabilizer 144 is coupled to at least one of the housing 104 and/or the shoe 138 in a relatively fixed manner. In this regard, the stabilizer 144 remains at a relatively fixed position while the blade 110 reciprocates within the object O.

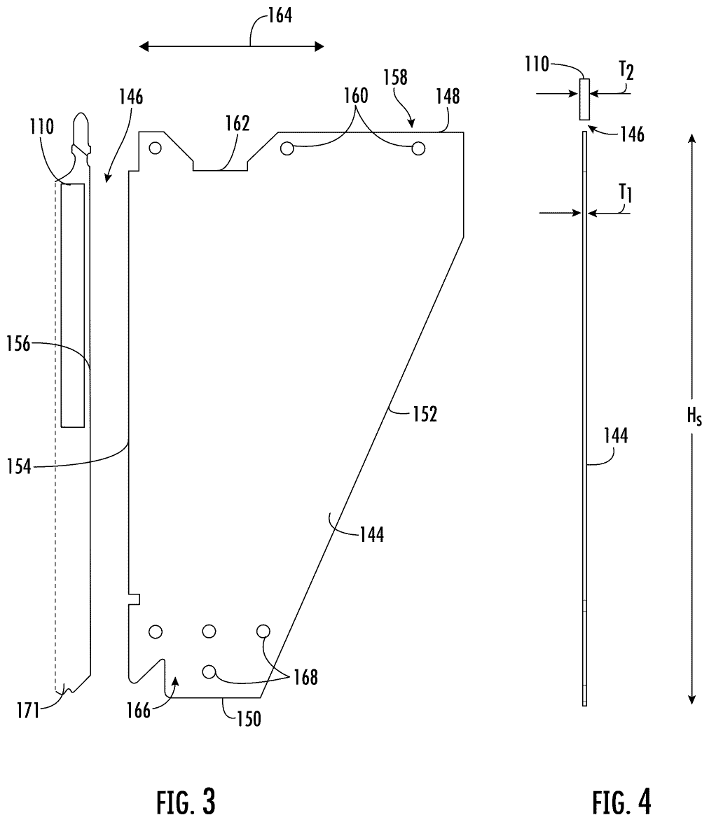

FIGS. 3 and 4 depict the stabilizer 144 and blade 110. In particular, FIG. 3 depicts a side view of the stabilizer 144 and blade 110, and FIG. 4 depicts a top view of the stabilizer 144 and blade 110. As depicted in FIGS. 3 and 4, the blade 110 is arranged stacked in front of the stabilizer 144. In this regard, the stabilizer 144 trails the blade 110. The stabilizer 144 is spaced apart from the blade 110 by a gap 146. The gap 146 may extend the entire length of the blade 110 such that the blade 110 does not contact (touch) the stabilizer 144. In an embodiment, the gap 146 can define a fixed (i.e., constant) dimension along an entire interface between the blade 110 and the stabilizer 144. That is, the blade 110 and the nearest surface of the stabilizer 144 can be separated by a relatively constant distance along the length of the gap 146. By way of non-limiting example, the gap 146 can be at least 1 millimeter (mm), such as at least 2 mm, such as at least 5 mm, such as at least 10 mm, such as at least 20 mm. The gap 146 may be less than 100 mm, such as less than 75 mm, such as less than 50 mm, such as less than 25 mm. In some instances, the gap 146 can be in a range between and including any of the values provided above.

In an embodiment, the stabilizer 144 is thinner than the blade 110. For instance, the stabilizer 144 can define a first thickness T₁ that is less than a second thickness T₂ of the blade 110. In an embodiment T₂ can be greater than 1.01 T₁, such as greater than 1.05 T₁, such as greater than 1.1 T₁, such as greater than 1.2 T₁, such as greater than 1.3 T₁, such as greater than 1.4 T₁, such as greater than 1.5 T₁, such as greater than 1.75 T₁, such as greater than 2 T₁. In this regard, the stabilizer 144 can follow the blade 110 into the kerf without restricting forward progress of the blade 110 further into the object O.

The stabilizer 144 may be formed from a semi-flexible (ductile) material such that the panel saw 100 can be turned relative to the object O with the blade 110 and stabilizer 144 both within the kerf. For example, the stabilizer 144 can be formed from a metal such as aluminum, brass, copper, or the like. The stabilizer 144 may also be formed from a polymer, a composite, or the like. As the panel saw 100 is guided on the object O, it is common for the operator to introduce bias into the handle 102 to turn the direction of the blade 110 relative to the object O, resulting in a curved kerf. Flexible stabilizer 144 construction permits the stabilizer 144 to turn, guided by the kerf walls.

The stabilizer 144 defines a proximal end 148 nearest to the housing 104 and a distal end 150 furthest from the housing 104. The stabilizer 144 can have a tapered profile that changes from a first dimension, as measured at the proximal end 148, to a second dimension, as measured at the distal end 150. The first dimension is larger than the second dimension. As such, the width of the stabilizer 144 decreases further away from the housing 104. In this regard, force on the stabilizer 144 created by friction with the sidewall of the kerf is reduced furthest from the housing 104, thereby minimizing drag and also allowing the stabilizer 144 to more easily bend to accommodate various kerf shapes. In one implementation, the taper is defined by a canted rear edge 152 of the stabilizer 144. The canted rear edge 152 can define a linear taper angularly offset from a front edge 154. The front edge 154 of the stabilizer 144 may be parallel with respect to a rear edge 156 of the blade 110. The rear edge 152 of the stabilizer 144 can be angularly offset (canted) with respect to the front edge 154 by at least 10°, such as at least 15°, such as at least 20°, such as at least 25°, such as at least 30°. In another implementation, the taper defines an arcuate taper, i.e., a curve, that lies along a best fit line that is angularly offset (canted) with respect to the front edge 154 by at least 10°, such as at least 15°, such as at least 20°, such as at least 25°, such as at least 30°. The arcuate taper can be, for example, concave.

The stabilizer 144 defines an attachment interface 158 for attaching to the housing 104 and/or the shoe 138. In the depicted embodiment, the attachment interface 158 includes an opening or a plurality of openings 160 extending through the stabilizer 144. The opening(s) 160 are arranged at or near the proximal end 148. The housing 104 and/or shoe 138 can define complementary attachment features to selectively secure to the opening(s) 160 to secure the stabilizer 144 to the housing 104. By way of example, the complementary attachment features can include openings that receive a pin or fastener. The openings of the complementary attachment features can be aligned with the openings 160 and pins can be inserted into both to retain the stabilizer 144. Alternatively, or in addition, the housing 104 and/or shoe 138 can define integral pin(s) or fastener(s) that engage with the opening(s) 160 to secure the stabilizer 144 to the housing 104. Yet other attachment protocol are contemplated herein. The disclosure is not intended to be limited by the above-described attachment interface.

The stabilizer 144 can include a keying feature 162 to properly arrange the stabilizer 144 relative to the housing 104 and/or shoe 138 during initial installation or re-assembly. By way of example, the keying feature 162 can include a pocket, slot, channel, recess, protrusion, finger, notch, or the like which interfaces with a complementary-shaped feature at the housing 104 and/or shoe 138. In the depicted embodiment, the keying feature 162 includes a chamfered pocket extending from the proximal end 148 towards the distal end 150. The chamfered pocket is shaped to interface with complementary structure of the shoe 138. The keying feature 162 further assists in transmitting force from the operator to the distal end 150 of the stabilizer 144 by preventing the stabilizer 144 from sliding or deforming in the front-rear direction indicated by double-sided arrow 164.

The distal end 150 of the stabilizer 144 can include a secondary attachment interface 166. In the depicted embodiment, the attachment interface 166 includes an opening or a plurality of openings 168 extending through the stabilizer 144. The opening(s) 168 are arranged at or near the distal end 150. Referring again to FIG. 1, the secondary attachment interface 166 is configured to receive a terminal guide structure 170 which supports a distal end 171 of the blade 110. The terminal guide structure 170 is depicted with complementary openings 174 which are aligned with the openings 168 for both to receive a fastener or pin (not illustrated).

The terminal guide structure 170 is positioned at the distal end of the stabilizer 144 and spaced apart from the shoe 138, and more particularly spaced apart from the support surface 140, by a distance greater than or equal to a thickness of the object O. Where the object O is insulated panel having a thickness T_{O} of six (6) inches, a smallest gap between the support surface 140 and the terminal guide structure 172 can be approximately equal to six (6) inches. Similarly, where the object O has a thickness T_{O} of five (5) inches, a smallest gap between the support surface 140 and the terminal guide structure 172 can be approximately equal to five (5) inches. Yet other dimensions can be selected based on the thickness T_{O} of the object O. In some instances, the stabilizer 144 can have an adjustable height H_{S} to accommodate objects O with different thicknesses. In other instances, the stabilizer 144 can be swapped with another stabilizer 144 having a different height H_{S} more suitable for the object O being cut. In yet other instances, the stabilizer can be used to cut objects having thicknesses less than the gap between the support surface 140 and the terminal guide structure 172.

The terminal guide structure 172 supports the blade 110 through its entire stroke, mitigating bending of the blade 110 and allowing the panel saw 100 to utilize sufficiently long blades 110 to pass through the object O. The terminal guide structure 172 supports the blade 110 against bending in directions 176, 178 and twisting about axis 180. These types of deformation are exacerbated as the length of the blade increases, thus requiring use of the terminal guide structure 172 for cutting objects O having thicknesses greater than two (2) inches, and more particularly for cutting objects O having thicknesses greater than five (5) inches, such as insulated panel.

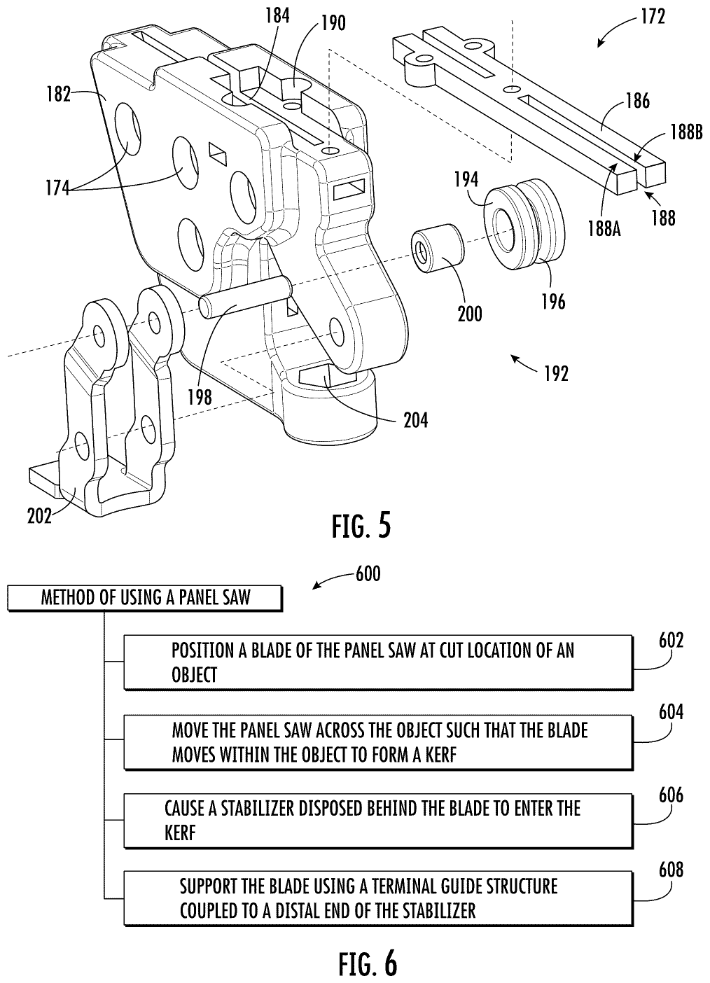

Referring to FIG. 5, the terminal guide structure 172 includes a base 182 defining the complementary openings 174 which are alignable with the secondary openings 168 arranged at or near the distal end 150 of the stabilizer 144 to secure the terminal guide structure 172 to the stabilizer 144. The terminal guide structure 172 can further include a receiver 184 defining a volume into which a portion of the stabilizer 144 can fit. The receiver 184, for example, can include a cutout or a slit extending into the base 182. A guide element 186 can be coupled to the base 182 and define a guide surface 188 for the blade 110. In the depicted embodiment, the guide element 186 is received in a cutout 190 of the base 182. The guide element 186 is secured to the base 182, for example by a threaded fastener. The guide element 186, due to its fixed connection with the stabilizer 144, remains relatively fixed with respect to the housing 104 as the user exerts force on the handle 102. Therefore, the guide surface 188 remains relatively fixed with respect to the housing 104, and more particularly with respect to the spindle 132 (FIG. 2). The guide surface 188 may thus structurally support the blade 110 opposite the spindle 132, mitigating bending 176, 168 and twisting 180. The guide surface 188 may be formed from a plurality of guide surfaces 188, 188, such as a left guide surface 188A and a right guide surface 188B. While the left and right guide surfaces 188A, 188B are labeled to correspond with particular surfaces in FIG. 4, it should be understood that these surfaces may be switched with respect to an operating direction. That is, the labeling of left and right is not intended to be limiting. The left and right guide surfaces 188A, 188B each support the respective side of the blade 110. In some implementations, support may be achieved through physical contact (i.e., rubbing). In other implementations, support may be achieved using a force generator, such as magnet(s), to support the blade 110 without contact.

The terminal guide structure 172 can further include a rear support 192 that supports the blade 110 from the rear edge 156. The rear support 192 can include, for example, a wheel 194 optionally defining a track 196 for the blade 110, and a spindle 198 supporting the wheel 194. The spindle 198 and wheel 194 can interface through a bearing 200. The spindle 198 is coupled to the base 182. In one implementation, the spindle is indirectly coupled to the base 182 through a frame 202. The frame 202 may be pivotally coupled to the base 182, for example, by a spindle (not shown). By rotating about the spindle, the frame 202 can be adjusted to affect (increase or decrease) pressure of the wheel 194 against the rear edge 156 of the blade 110 (blade pressure). The terminal guide structure 172 can further include an adjustment interface that allows the operator to selectively increase or decrease blade pressure. The adjustment interface can include, for example, an opening 204 through which a tensioner (not illustrated) extends. The tensioner can interact with the frame 202 to rotate the frame 202 about a pivot point formed by the spindle. In an embodiment, the opening 204 can be threaded and the tensioner can include a threaded rod that is rotatable within the opening 204 to pivot the frame 202. By rotating the threaded rod in a first direction, the frame 202 is pivoted in a first direction causing the wheel 194 to push into the rear edge 156 of the blade 110. Conversely, by rotating the threaded rod in a second direction opposite the first direction, the frame 202 is pivoted in a second direction causing the wheel 194 to move away from the rear edge 156 of the blade 110. In certain implementations, the adjustment interface can include a torque limiter or other similar component that prevents overtightening of the threaded rod (or other tensioning implement) to avoid overtensioning the blade 110.

In some implementations, the blade 110 may be supported by a plurality of wheels, including the wheel 194 at the terminal guide structure 172 and a secondary wheel 206 (FIG. 2). The secondary wheel 206 may be arranged above the object O while the wheel 194 is arranged below the object O. The blade 110 may thus be supported by wheels 194, 206 disposed on opposite sides of the object O being cut. This support can prevent excessive torque loading on the spindle 132, thereby increasing operational lifespan of the panel saw 100, permitting a user to introduce additional force to the handle 102 without compromising integrity of the panel saw 100, and the like.

Referring again to FIG. 1, the blade 110 may be further supported by a second guide element 208. The second guide element 208 can be disposed generally near the shoe 138. The second guide element 208 can be supported by the housing 104, the shoe 138, or both. Similar to the guide element 186, the second guide element 208 can structurally support the blade 110, mitigating bending 176, 168 and twisting 180. The second guide element 208 may be formed from a plurality of guide surfaces, such as a left guide surface and a right guide surface. The left and right guide surfaces each support the respective side of the blade 110. In some implementations, support may be achieved through physical contact (i.e., rubbing). In other implementations, support may be achieved using a force generator, such as magnet(s), to support the blade 110 without contact.

FIG. 6 is a flow chart of a method 600 of using the panel saw in accordance with an example embodiment. In general, the method 600 will be described with reference to a panel saw 100 as depicted, for example, in FIGS. 1 to 5. In addition, although FIG. 6 depicts steps performed in a particular order for purposes of illustration and discussion, the method discussed herein is not limited to any particular order or arrangement. One skilled in the art, using the disclosure provided herein, will appreciate that various steps of the method disclosed herein can be omitted, rearranged, combined, and/or adapted in various ways without deviating from the scope of the present disclosure.

The method 600 includes positioning a blade of the panel saw at a cut location of an object 602. The cut location can correspond to an entry point into the object, such as for example, a location along a perimeter of an object where a cut into the object is to be initiated. In some instances, the cut location may correspond to a current cut location where the blade was last operated, i.e., a location at a distal end of an existing kerf.

Positioning the blade can include aligning the blade relative to the object. For instance, a shoe of the panel saw can be generally aligned with a major surface of the object. The blade can be introduced to an edge of the object and the operator can actuate a throttle to initiate reciprocation of the blade.

Typically, the object is cut in a perpendicular manner with the blade plunging into the object perpendicular to the major surface upon which the shoe is supported. However, in some applications it is necessary to form an angled cut in the object. The angle of the cut can be controlled by a relative angular displacement between the shoe and the blade. To affect an angled cut, the operator can rotate the shoe laterally, i.e., about a centerline extending in a front-rear direction. The operator can lock the shoe at the desired angle and commence cutting.

The method 600 further includes moving the panel saw across the object such that the blade moves within the object to form, or continue forming, a kerf 604. The kerf is defined by a path previously taken by the blade through the object. As the panel saw moves within the object, the kerf becomes longer. When starting the kerf from the perimeter of the object, the blade initially enters the kerf without the stabilizer disposed within the kerf. However, after penetrating into the object a sufficient distance, the stabilizer disposed behind the blade enters the kerf 606. The blade continues to reciprocate while the stabilizer follows the blade without reciprocating. The stabilizer supports a terminal guide structure which is disposed on an opposite side of the object with respect to a housing of the panel saw. The terminal guide structure moves relative to the object as the panel saw is advanced. The terminal guide structure supports the blade 608. Support provided by the terminal guide structure includes support against bending in a lateral direction or twisting about an axis oriented generally parallel to a length of the blade.

In some instances, the operator may adjust one or more support characteristics associated with the support provided to the blade by the terminal guide structure. For example, where the terminal guide structure includes a wheel that guides and supports a rear edge of the blade, a relative pressure between the wheel and the rear edge of the blade may be adjustable. By adjusting pressure between the wheel and the blade, the operator can compensate for wear, prepare for various cutting techniques or material properties, or the like.

Once entering the kerf, the stabilizer remains within the kerf for the duration of the cut. The stabilizer may flex to allow for cutting of arcuate kerf shapes. Alternatively, the stabilizer may be rigid and act as a guide that prevents the blade from turning. That is, the stabilizer may be supported against rotation by the kerf sidewalls, limiting turning of the blade. In this regard, the stabilizer may be used to form straight cuts within the object without requiring an external guide or straight edge.

In some implementations, the relative amount of curvature in the kerf permitted by the stabilizer, i.e., how easily the panel saw may be turned after the stabilizer is within the kerf, may be determined at least in part by a thickness of the stabilizer relative to blade thickness. Where the stabilizer and blade have common, or generally similar, thicknesses, the panel saw may be more difficult to turn. Conversely, where the stabilizer is considerably thinner than the blade (e.g., 50% thinner than the blade), the panel saw may more easily turn over large radius turns.

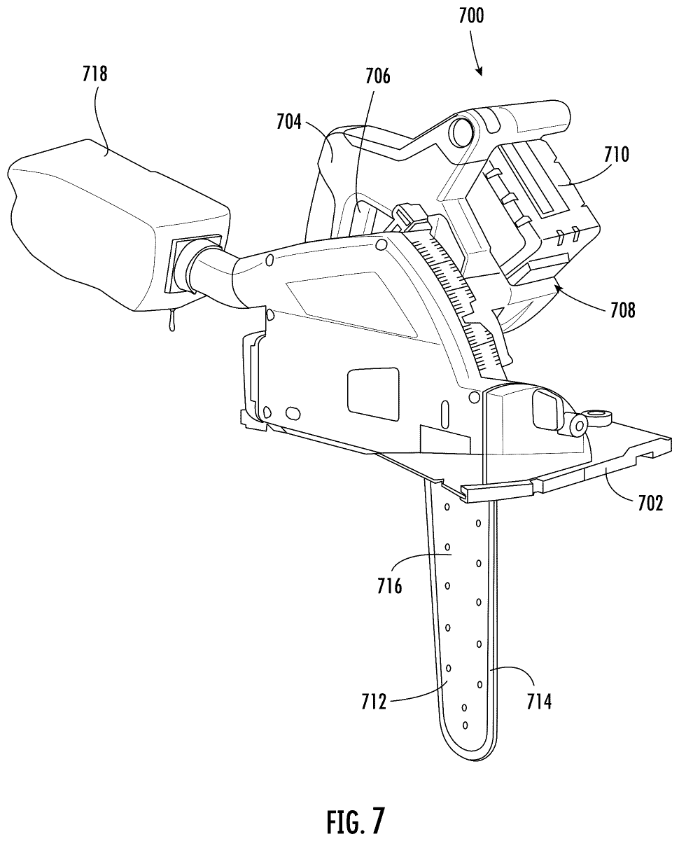

FIG. 7 illustrates the panel saw 700 in accordance with another embodiment. In the depicted embodiment, the panel saw 700 can include a guide 702, a body 704 coupled to the guide, a handle 706 coupled to the body 704 (e.g., unitary with the body 704 or a portion thereof), a power source receiving area 708, a removable power source 710 (e.g., a direct current (DC) battery), and a saw 712 which is driven by a motor (not illustrated) powered by the removable power source 710. The saw 712 can include an infinite chain 714 movable about a bar 716. The motor can include a drive gear (not illustrated) that interfaces with the infinite chain 714 to move the chain 714 about the bar 716. In an embodiment, the chain 714 includes cutting elements, such as teeth, that cut into panels having foam disposed between metal sides.

In an embodiment, the bar 716 can define a major axis that intersects the power source 710, at least when viewed from one side of the panel saw 700. This may enhance balance of the panel saw 700 when operating with a power source 710 weighing more than one (1) or two (2) pounds (lbs). In another embodiment, the power source 710 can be disposed between the handle 706 and the major axis. In yet another embodiment, the handle 706 can be disposed between the power source 710 and the major axis. Yet other spatial arrangements are possible.

In some instances, the power source 710 can be removed from the power source receiving area 708 by moving the power source 710 in a direction away from the bar 716. In an embodiment, the power source 710 is removed from the power source receiving area 708 by translating the power source 710 in a forward direction, a rear direction, an upwards direction, or any combination thereof. In some implementations, the power source 710 may also be removed through a translational, or roto-translational movement. Installing the power source 710 at the power source receiving area 708 can be performed in reverse.

The panel saw 700 can further include a dust extraction system 718 (e.g., a dust collection vessel).

The power source receiving area 708 can include electrical contacts configured to engage with complementary electrical contacts on the power source 710 to form a communication pathway between the motor and the power source 710. The panel saw 700 can include control circuitry that couples the power source 710 to the motor. In certain instances, the panel saw 700 includes one or more features that enhance operational aspects of the panel saw 700.

The panel saw may have different types of arrangements. For example, as depicted below, the panel saw can include a first handle disposed at a rear side of the panel saw and a second handle having an orientation parallel with an axis of the drive gear (not illustrated). In an embodiment, the power source receiving area 708 is disposed behind the handle and/or the second handle, e.g., at a rear side of the panel saw. In another embodiment, the power source receiving area 708 may be disposed in front of the handle and/or the second handle, e.g., at a middle portion or front side of the panel saw.

In an embodiment, the panel saw includes a brushless direct current (“BLDC”) motor, electronics for controlling and monitoring the operation of the panel saw, and the like. The panel saw can include a housing, a trigger switch, a plurality of power terminals, a plurality of power switching elements, a motor controller, a BLDC motor, and an output shaft. The trigger switch is configured to selectively output a trigger signal to the motor controller. The power terminals are positioned within the housing of the panel saw and are configured to receive electric current from the power source. The power switching elements are positioned within the housing of the panel saw and are electrically connected to the power terminals. The motor controller is electrically connected to the power switching elements and to the trigger switch to receive the trigger signal. The motor controller is configured to selectively enable and disable the power switching elements based on the trigger signal. The BLDC motor is electrically connected to the power switching elements such that the selective enabling and disabling of the power switching elements selectively provides power to the BLDC motor. The panel saw having an average sustained (e.g., long-run) power output of at least approximately 300 Watts. The output shaft coupled to and rotationally driven by the BLDC motor to provide an output force.

In another embodiment, the panel saw includes a housing, a trigger switch, a first power source terminal, a second power source terminal, a brushless direct-current (“BLDC”) motor, a switching array, a controller, and an output shaft. The housing includes a body and a handle portion. The trigger switch is configured to generate a trigger signal. The first power source terminal and the second power source terminal are configured to electrically connect to a power source. The power source includes a plurality of lithium-based battery cells, and the power source is removably coupled to the panel saw. The switching array includes a plurality of switches electrically connected between the BLDC motor and the first power source terminal and the second power source terminal. The controller is configured to receive the trigger signal from the trigger switch, and generate a control signal based on the trigger signal to selectively enable and disable each of the plurality of switches in the switching array to drive the BLDC motor with power provided from the power source. The output shaft is coupled to the BLDC motor to provide an output of the panel saw, and the panel saw is operable to produce an average long-duration power output of at least 300 Watts (“W”) and a maximum short-duration power output of at least 400 W.

In another embodiment, the panel saw includes a first battery terminal, a second battery terminal, a brushless direct-current (“BLDC”) motor, a switching array, a controller, and an output shaft. The first power source terminal and the second power source terminal are configured to electrically connect to a power source. The power source includes a plurality of lithium-based battery cells, and the power source is removably coupled to the panel saw. The switching array includes a plurality of switches electrically connected between the BLDC motor and the first power source terminal and the second power source terminal. The controller is configured to generate a control signal to selectively enable and disable each of the plurality of switches in the switching array to drive the BLDC motor with power provided from the power source. The output shaft is coupled to the BLDC motor to provide an output of the panel saw, and the panel saw is operable to produce a maximum short-duration power output of at least 450 W.

Yet other arrangements and configurations are possible.

Using a battery-operated panel saw as described in accordance with embodiments herein allows operation over a larger worksite area than currently possible with traditional panel saws. Traditionally, panel saws are coupled to external power through a cord connected to a wall outlet power source. Embodiments described herein are not coupled to external power through a cord.

Further aspects of the invention are provided by one or more of the following embodiments:

Embodiment 1. A panel saw comprising: a housing supporting a motor-driven spindle that moves in reciprocation; a blade coupled to the spindle; a stabilizer extending away from the housing and spaced apart from the blade; a terminal guide structure coupled to a distal end the stabilizer, wherein the terminal guide structure comprises: one or more lateral guide surfaces configured to support the blade in a desired cutting plane; a rear support configured to support a rear edge of the blade; or a combination thereof.

Embodiment 2. The panel saw of embodiment 1, wherein the rear support comprises a wheel configured to exert pressure against the rear edge of the blade, and wherein the pressure is user adjustable.

Embodiment 3. The panel saw of any one or more of embodiments 1 or 2, wherein the housing and the terminal guide structure are spaced apart from one another by at least five inches, as measured in a direction parallel to a length of the blade.

Embodiment 4. The panel saw of any one or more of embodiments 1 to 3, wherein the stabilizer has a tapered profile with a widest dimension proximate to the housing and a narrowest dimension proximate to the terminal guide structure.

Embodiment 5. The panel saw of embodiment 4, wherein the stabilizer includes a front edge oriented generally parallel with the rear edge of the blade and a canted rear edge that is angularly offset from the front edge by at least 10°.

Embodiment 6. The panel saw of any one or more of embodiments 1 to 5, wherein the stabilizer is removable from the housing with the terminal guide structure remaining coupled to the stabilizer.

Embodiment 7. The panel saw of any one or more of embodiments 1 to 6, wherein the stabilizer has a thickness, as measured perpendicular to a direction of travel during a cutting operation, less than a thickness of the blade.

Embodiment 8. The panel saw of any one or more of embodiments 1 to 7, wherein the one or more lateral guide surfaces comprises a left guide surface and a right guide surface, wherein the blade is disposed between the left and right guide surfaces, wherein the terminal guide structure comprises both the lateral guide surfaces and the rear support, and wherein the rear support comprises a wheel having a track to receive the blade.

Embodiment 9. An attachment for a panel saw configured to cut thick objects, the attachment comprising: a stabilizer defining a proximal end and a distal end, the stabilizer comprising a proximal attachment protocol disposed at the proximal end and a distal attachment protocol disposed at the distal end, wherein the proximal attachment protocol is configured to attach the stabilizer to a housing of the panel saw, the housing containing a motor configured to drive a spindle to reciprocate a blade; a terminal guide structure coupled to the stabilizer at the distal attachment protocol, wherein the terminal guide structure comprises: a lateral guide surface configured to support a lateral aspect of the blade of the panel saw in a desired cutting plane; a rear support configured to support a rear edge of the blade; or a combination thereof.

Embodiment 10. The attachment of embodiment 9, wherein the stabilizer has a thickness, as measured perpendicular to a direction of travel during a cutting operation, less than a thickness of the blade.

Embodiment 11. The attachment of any one or more of embodiments 9 or 10, wherein the rear support comprises a wheel configured to exert pressure against the rear edge of the blade, and wherein the pressure is user adjustable.

Embodiment 12. The attachment of any one or more of embodiments 9 to 11, wherein the terminal guide structure is spaced apart from the proximal attachment protocol by at least five inches, as measured in a direction parallel to a length of the blade.

Embodiment 13. The attachment of any one or more of embodiments 9 to 12, wherein the lateral guide surface comprises a left guide surface and a right guide surface, wherein the terminal guide structure is configured to receive the blade between the left and right guide surfaces, wherein the terminal guide structure comprises both the lateral guide surfaces and the rear support, and wherein the rear support comprises a wheel having a track to receive the blade.

Embodiment 14. The attachment of any one or more of embodiments 9 to 13, wherein the stabilizer includes a front edge configured to be oriented generally parallel with the rear edge of the blade and a canted rear edge that is angularly offset from the front edge by at least 10°.

Embodiment 15. The attachment of any one or more of embodiments 9 to 14, wherein the attachment is removable from the housing without removing the blade from the housing.

Embodiment 16. A method of using a panel saw, the method comprising: positioning a blade of the panel saw at a cut location of an object; moving the panel saw across the object such that the blade moves within the object to form a kerf; causing a stabilizer disposed behind the blade to enter the kerf, wherein the stabilizer extends fully through the object such that a distal end of the stabilizer is exposed from the object; and supporting the blade using a terminal guide structure coupled to the distal end of the stabilizer.

Embodiment 17. The method of embodiment 16, wherein the panel saw comprises a housing supporting a motor-driven spindle moving in reciprocation, wherein the blade is coupled to the spindle, and wherein the stabilizer is statically coupled to the housing such that a distance between the terminal guide structure and the housing remains relatively fixed while the blade reciprocates.

Embodiment 18. The method of any one or more of embodiments 16 or 17, wherein supporting the blade using the terminal guide structure comprises supporting a lateral side of the blade using a guide surface of the terminal guide structure and supporting a rear edge of the blade using a wheel of the terminal guide structure.

Embodiment 19. The method of embodiment 18, wherein a blade pressure generated between the wheel and the rear edge of the blade is adjustable.

Embodiment 20. The method of any one or more of embodiments 16 to 19, further comprising removing the stabilizer from the panel saw while the blade remains attached to a motor driving the blade.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A panel saw comprising:
a housing supporting a motor-driven spindle that reciprocates;
a blade coupled to the spindle;
a stabilizer extending away from the housing and spaced apart from the blade;
a terminal guide structure coupled to a distal end the stabilizer, wherein the terminal guide structure comprises:
one or more lateral guide surfaces configured to support the blade in a desired cutting plane;
a rear support configured to support a rear edge of the blade; or
a combination thereof.

2. The panel saw of claim 1, wherein the rear support comprises a wheel configured to exert pressure against the rear edge of the blade, and wherein the pressure is user adjustable.

3. The panel saw of claim 1, wherein the housing and the terminal guide structure are spaced apart from one another by at least five inches, as measured in a direction parallel to a length of the blade.

4. The panel saw of claim 1, wherein the stabilizer has a tapered profile with a widest dimension proximate to the housing and a narrowest dimension proximate to the terminal guide structure.

5. The panel saw of claim 4, wherein the stabilizer includes a front edge oriented generally parallel with the rear edge of the blade and a canted rear edge that is angularly offset from the front edge by at least 10°.

6. The panel saw of claim 1, wherein the stabilizer is removable from the housing with the terminal guide structure remaining coupled to the stabilizer.

7. The panel saw of claim 1, wherein the stabilizer has a thickness less than a thickness of the blade.

8. The panel saw of claim 1, wherein the one or more lateral guide surfaces comprises a left guide surface and a right guide surface, wherein the blade is disposed between the left and right guide surfaces, wherein the terminal guide structure comprises both the lateral guide surfaces and the rear support, and wherein the rear support comprises a wheel having a track to receive the blade.

9. An attachment for a panel saw configured to cut thick objects, the attachment comprising:
a stabilizer defining a proximal end and a distal end, the stabilizer comprising a proximal attachment protocol disposed at the proximal end and a distal attachment protocol disposed at the distal end, wherein the proximal attachment protocol is configured to attach the stabilizer to a housing of the panel saw, the housing containing a motor configured to drive a spindle to reciprocate a blade;
a terminal guide structure coupled to the stabilizer at the distal attachment protocol, wherein the terminal guide structure comprises:
a lateral guide surface configured to support a lateral aspect of the blade of the panel saw in a desired cutting plane;
a rear support configured to support a rear edge of the blade; or
a combination thereof.

10. The attachment of claim 9, wherein the stabilizer has a thickness, as measured perpendicular to a direction of travel during a cutting operation, less than a thickness of the blade.

11. The attachment of claim 9, wherein the rear support comprises a wheel configured to exert pressure against the rear edge of the blade, and wherein the pressure is user adjustable.

12. The attachment of claim 9, wherein the terminal guide structure is spaced apart from the proximal attachment protocol by at least five inches, as measured in a direction parallel to a length of the blade.

13. The attachment of claim 9, wherein the lateral guide surface comprises a left guide surface and a right guide surface, wherein the terminal guide structure is configured to receive the blade between the left and right guide surfaces, wherein the terminal guide structure comprises both the lateral guide surfaces and the rear support, and wherein the rear support comprises a wheel having a track to receive the blade.

14. The attachment of claim 9, wherein the stabilizer includes a front edge configured to be oriented generally parallel with the rear edge of the blade and a canted rear edge that is angularly offset from the front edge by at least 10°.

15. The attachment of claim 9, wherein the attachment is removable from the housing without removing the blade from the housing.

16. A method of using a panel saw, the method comprising:
positioning a blade of the panel saw at a cut location of an object;
moving the panel saw across the object such that the blade moves within the object to form a kerf;
causing a stabilizer disposed behind the blade to enter the kerf, wherein the stabilizer extends fully through the object such that a distal end of the stabilizer is exposed from the object; and
supporting the blade using a terminal guide structure coupled to the distal end of the stabilizer.

17. The method of claim 16, wherein the panel saw comprises a housing supporting a motor-driven spindle moving in reciprocation, wherein the blade is coupled to the spindle, and wherein the stabilizer is statically coupled to the housing such that a distance between the terminal guide structure and the housing remains relatively fixed while the blade reciprocates.

18. The method of claim 16, wherein supporting the blade using the terminal guide structure comprises supporting a lateral side of the blade using a guide surface of the terminal guide structure and supporting a rear edge of the blade using a wheel of the terminal guide structure.

19. The method of claim 18, wherein a blade pressure generated between the wheel and the rear edge of the blade is adjustable.

20. The method of claim 16, further comprising removing the stabilizer from the panel saw while the blade remains attached to a motor driving the blade.
